(19) United States
(12) Patent Application Publication
(10) Pub. No.: US 2002/0038436 A1
(43) Pub. Date: Mar. 28, 2002

(54) Disk array apparatus, error control method for the same apparatus, and control program for the same method

(75) Inventor: Atsutomo Suzuki, Tokyo (JP)

Correspondence Address: SUGHRUE, MION, ZINN,, MACPEAK & SEAS, 2100 Pennsylvania Avenue, N.W., Washington, DC, 20037, US

(73) Assignee: NEC CORPORATION

(21) Appl. No.: 09/956,019

(22) Filed: Sep. 20, 2001

(30) Foreign Application Priority Data
Sep. 28, 2000 (JP) 296323/2000

(51) Int. Cl. H04L 1/22

(52) U.S. Cl. 714/6

(57) ABSTRACT

To provide a disk array apparatus, which possesses capability to deal with data read/write errorswithout delaying its essential operations and to avoid operations that allow normal disk devices to be set in a degeneration state. The disk array apparatus includes: a failed disk specifying and storage part which detects and stores which disk device is failed; a disconnection state manager which temporarily disconnects the failed disk device and manages the disk array apparatus in temporary degeneration operation; an instruction execution unit for allowing the normal disk devices to perform data read/write operations using redundancy with upper devices when receiving data read/write instructions during temporary degeneration operation; a retry part which performs retry for the failed disk device in parallel with performing data read/write operations with upper devices; and a turning off and resupplying power unit for turning off and then resupplying power to the failed disk device if normal completion is not achieved by retry.

### BACKGROUND OF THE INVENTION

1. Field of the Invention

The present invention relates to a disk array apparatus widely used as a data storage device in an information processing system, an error control method of the disk array apparatus, and a control program for the error control method.

2. Description of the Related Art

A disk array apparatus according to the present invention has a configuration, in which plural disk devices constitute a logical disk, and adopts the Redundant Array Independent Disks (RAID) system, which add redundant information to data and then write it into a disk.

Generally, such disk array apparatus receives data read/write instructions from a host computer. If data read/write operations for a specified logical disk are not normally completed, a failed disk device is disconnected from the logical disk to set the logical disk in a degeneration state, allowing data read/write operations to be continued with the remaining disk devices. The above-described logical disk comprises plural physical disks and a controller which controls the disks, and logically behaves as one drive for upper devices.

Recently, however, with increase of storage capacity and memory density in a disk device, error incidence in data read/write operations due to disk failures or the like has been increased. Conventionally, if data read/write operations are not normally completed in such a disk array apparatus, the operations are performed again or reassigned in the disk array apparatus. If read/write operations can be normally completed by retry, the normal operations are continued. On the other hand, if retry or reassignment can not normally complete read/write operations, a failed disk device is disconnected from the logical disk, allowing the logical disk to be set in a degeneration state.

In this way, the probability can be decreased that the logical disk will shift to a degeneration state, and the logical disk can be controlled so as to avoid the decrease of reliability due to degeneration operations without redundancy. Recently, however, the use of such disk array apparatus for continuous write/read operations in moving pictures has been increased, so that processing time for sending and receiving data to/from a host computer is required to be reduced.

Therefore, even if a disk device essentially can resume normal data read/write operations by retry operations, such as reassignment processing, if an enough retry time is given, the retry time is not adequately provided for the disk array device and the disk device is disconnected from the logical disk to set the logical disk in a degeneration state. The reason is that data read/write operations for a host computer must be completed in a required time. Then, data read/write operations are completed with the remaining normal disk devices, and the disk device is considered a failed one to be replaced with another normal disk device.

However, degeneration of the disk device essentially capable of performing normal read/write operations via appropriate processes, such as data rewrite operations and reassignment decreases reliability of the logical disk. Furthermore, maintenance or replacement of the disk device as a failed disk device is not economical.

To solve this problem, Japanese Patent Laid-Open No. 11-338648 discloses that if any problems are detected during data read/write operations, a failed disk device is temporarily disconnected from the logical disk, allowing the logical disk to be set in a degeneration state. In addition, the data read/write operations are continued based on redundant data stored in the remaining normal disk devices, and appropriate retry, such as reassignment, is performed in the failed disk device asynchronously with data read/write operation instructions from a host computer. As a result, if data read/write operations are completed without any problems, the failed disk device is determined to be normal and incorporated again into the logical disk, which is in the temporary degeneration state. This method decreases the probability that logical disk is set in a regular degeneration state (involving maintenance and replacement of failed disk devices), resulting that the decrease of reliability during recovery operations, such as maintenance and replacement, may be minimized.

In this related art document, if data read/write operations are not normally completed by either retry performed by a retry part 712b shown in FIG. 7 or re-operations after reassignment, the failed disk device is set in a regular degeneration state. This process is specifically described in the document.

The primary problem of the above-described document is that a temporary degeneration state can be canceled only when the cause of incompletion of both the retry of data read/write operation and the same after reassignment can be eliminated by reassignment processing, which includes a defect in amedium in a disk device, and any failure which can be eliminated only by turning off/resupplying power results in a regular degeneration state.

### SUMMARY OF THE INVENTION

It is therefore an object of the present invention to provide a disk array apparatus which can solve problems of a failed disk device by retry processing and connect the disk device to the logical disk again to cancel a temporary degeneration state and recover reliability of the logical disk even if the problems include not only defects in a medium but also errors to be solved by turning off/resupplying power operations for the disk device.

A disk array apparatus according to the present invention having plural disk devices with redundancy for performing-data read/write operations between the disk array apparatus and a host computer in response to data read/write instructions from the host computer, comprises:

a failed disk specifying and storage part which detects errors in either data write or read operations and stores which disk device is failed;

a disconnection state manager which disconnects temporarily a failed disk device and manages the disk array apparatus under temporary degeneration operation;

an instruction execution part which allows the remaining normal disk devices toperformdata read/write operations using redundancy when receiving data read/write instructions from the host computer during a temporary degeneration operation;

a retry part which performs retry of incomplete data read/write operations at the failed disk device in parallel with performing data read/write operations between the disk devices and the host computer; and

a turning off and resupplying power part which turns off and then resupplies power to the device if normal completion is not achieved with retry by the retry part,

wherein the retry part performs retry again after turning on the power for the device.

In another aspect, the disk array apparatus according to the present invention, further comprises:

a reconnection part which cancels the temporary disconnected state of a failed disk device and returns the disk array apparatus from temporary degeneration operation to the normal operation if the failed disk device becomes normal after retry by the retry part.

In another aspect, the disk array apparatus according to the present invention stores history of the following process into the disk array controller if the turning off and resupplying power part turns off and resupplies power to the failed disk device, and then the retry part performs retry to achieve normal completion and the reconnection part connect the temporarily disconnected disk device to the disk array apparatus.

In another aspect of the disk array apparatus according to the present invention, the turning off and resupplying power part comprises:

a disk power controller which transmits a signal to a switch part connected to the failed disk device specified by the failed disk specifying and storage part to turn off the switch for a predetermined time from the moment specified by the failed disk specifying and storage part; and

a switch part, which is connected between the disk device and power supply of the disk device, normally supplying power current to the disk device from the power supply and cutting off the power current during receiving a turning off signal from the disk power controller.

In another aspect, the disk array apparatus according to the present invention possesses the disk power controller comprising:

a turning off time set timer which outputs an instruction signal to a disk selector from the moment instructed by the failed disk specifying and storage part for a time predetermined depending on types of disk devices; and

a disk selector which transmits a turning off signal to the switch part that is connected with the failed disk device specified by the failed disk specifying and storage part while the instruction signal is transmitting from the turning off time set timer.

An error control method according to the present invention, which is a method for controlling errors in disk array apparatus that is provided with plural disk devices with redundancy and performs data read/write operations between the disk array apparatus and a host computer corresponding to data read/write instructions from the host computer, comprising:

a step 1 of detecting any problems in either data write or read operations and storing which disk device is failed;

a step 2 of temporarily disconnecting the failed disk device and managing the disk array apparatus under temporary degeneration operation;

a step 3 of allowing the remaining normal disk devices to perform data read/write operations with the host computer using redundancy in response to data read/write instructions from the host computer during temporary degeneration operation;

a step 4 of performing retry of incomplete data read/write operations at the failed disk device in parallel with performing data read/write operations between the disk array apparatus and the host computer; and

a step 5 of turning off and then resupplying power to the failed disk device if the retry by the step 4 cannot normally finish the incomplete data read/write operations,

wherein the step 4 is further performed after performing the step 5.

In another aspect, the error control method for the disk array apparatus according to the present invention, further comprising:

a step 6 of canceling a temporary disconnected state of the failed disk device and returning the disk array apparatus from temporary degeneration operation to the normal operation if the failed disk device becomes normal after retry in the step 4.

In another aspect, the error control method for the disk array apparatus, wherein in the step 4, failed operations are performed again to confirm whether the same problems occur and the failure history is stored if the same problems do not occur.

In another aspect, the error control method for the disk array apparatus, wherein in the step 4, data at a failed position is re-written so as to be normally read.

In another aspect, the error control method for the disk array apparatus, wherein in the step 4, a failed position in the failed disk device is prohibited to be used and then a replacement position is reassigned if the failure is a read error due to physical defects in the medium.

### BRIEF DESCRIPTION OF THE DRAWINGS

The novel features believed characteristic of the invention are set forth in the appended claims. The invention itself, however, as well as other features and advantages thereof, will be best understood by reference to the detailed description which follows, read in conjunction with the accompanying,.wherein:

FIG. 1 is a block diagram showing a structure of disk array apparatus according to the present invention;

FIG. 2 is a flow chart of processing operation of a disk array controller;

FIG. 3 is a flow chart of processing operation of a disk array controller;

FIG. 4 is a flow chart of processing operation of a disk array controller;

FIG. 5 is a block diagram of a structure of a disk power controller;

FIG. 6 is a block diagram of a structure and connection relation of the switch part shown in FIG. 1; and

FIG. 7 is a block diagram of a structure of a temporary degeneration controller in a disk array apparatus in the related art.

### DESCRIPTION OF THE PREFERRED EMBODIMENTS

A disk array apparatus and error control method therefor according to the present invention will be described below.

A disk array apparatus according to the present invention is provided with plural disk devices, in which at least one redundant disk device is included or redundant memory capacity equal to one disk device is provided, adds redundant data to write data transmitted from a host computer and assigns the data to each disk device, and recovers the assigned data to transmit to the host computer when receiving data read instructions.

As a special structure of the disk array apparatus according to the present invention, the same data is written into plural disk devices, and the data may be read from any of the disk devices (e.g., RAID-1 structure). In the above-described methods, the disk array apparatus according to the present invention recovers correct data using redundant data stored in the remaining disk devices if a disk device is failed.

In the disk array apparatus provided with the above-described structure, if problems are detected during data read or write operations, which are performed corresponding to data read or write instructions from a host computer, more specifically, a disk device transmits an error report, such as read error occurrence, or a time-out state, in which response is not returned in a predetermined time, is detected, the failed disk device is temporarily disconnected, allowing the disk array apparatus to be set in degeneration operation (hereinafter, referred to as temporary degeneration operation).

When one of the plural disk devices begins temporary degeneration operation, data recoverymeans, which is provided in the disk array apparatus, is employed to transmit recovery data to a host computer and normally complete read instructions. At the same time, any of the following process (1) to (4) is performed for the disk device under the temporary degeneration operation:

(1) Perform failed operations again to confirm whether the same errors occur. In the case of no error, the error history is stored and further processing is not performed.

(2) Re-write data at the position where read errors occurred so as to be normally read.

(3) If partial, physical defects in the medium cause errors, prohibit the disk array apparatus from using the failed position and assign an alternative position, which is referred to as reassignment processing. After the reassignment processing, perform the failed operations again.

(4) Turn off and then resupply power to the disk device to return the device to normal read/write operations.

Subsequently, the temporary degeneration operation is canceled to return the disk device to normal operation. In addition, the above-described processing for the disk device under the temporary degeneration operation is performed in parallel with executing instructions from the host computer.

If the disk device under the above-described temporary degeneration operation receives new read instructions from the host computer, the disk array apparatus allows the disk device to be under degeneration operation and transmits data to the host computer by data recovery means (data recovery using the remaining disk devices).

If the disk device under the above-described temporary degeneration operation receives write instructions from the host computer, the disk array apparatus allows the disk device to be under degeneration operation and writes data into the remaining disk devices. At this point, locations (block addresses), at which data is written, are sequentially stored. When internal processing, such as assignment and replacement operations, for the disk device under the temporary degeneration operation is completed, data at the stored block addresses is sequentially recoveredusing data in the remaining disk devices, and then the temporary degeneration operation is canceled to resume the normal operation.

With this method, the disk array apparatus having such a structure does not shift to regular (long time) degeneration operation. Therefore, if next error occurs before completing data recovery, the possibility that data cannot be read will decrease, enabling the disk array apparatus to continue stable operations.

Embodiments of a disk array apparatus and error control method therefor according to the present invention will be described below with reference to the drawings.

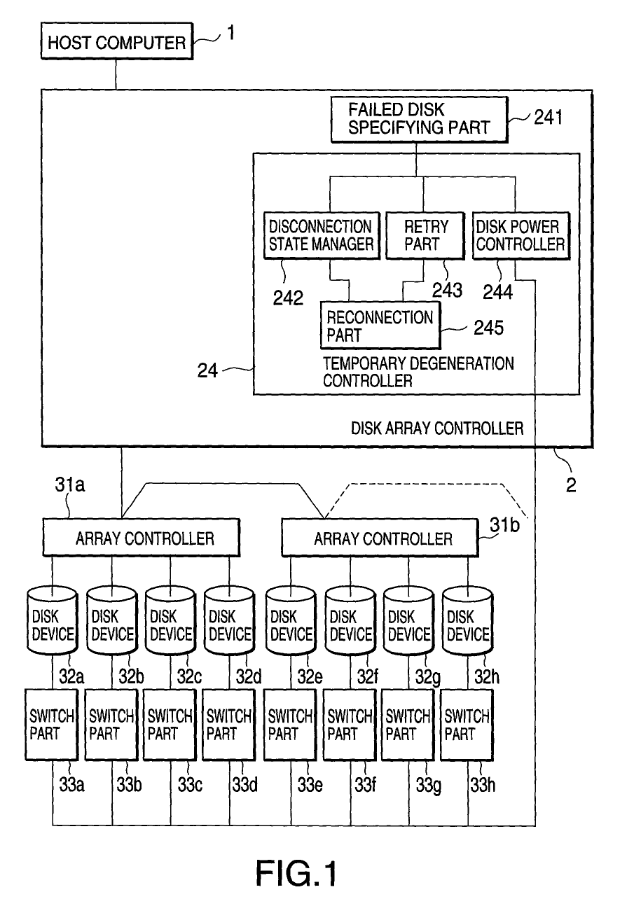

With reference to FIG. 1, a disk array apparatus according to a first embodiment of the present invention possesses a disk array controller 2, which includes a temporary degeneration state controller 24 and a failed disk specifying part 241, array controllers 31a, 31b, disk devices 32a to 32d and 32e to 32h, and switch parts 33a to 33d and 33e to 33h. This apparatus may be RAID-3 or RAID-5 system. The disk devices 32a to 32d and 32e to 32h possess redundancy, and perform read/write operations according to data read/write instructions from a host computer 1. Hereinafter, four disk devices 32a to 32d controlled by the array controller 31a are employed. In this embodiment, the disk devices 32e to 32h are controlled by the array controller 31b in the same way, and the present invention can be adopted even if three or more than four disk devices are employed.

In FIG. 1, the disk array controller 2 possesses the failed disk specifying part 241 and the temporary degeneration controller 24. The temporary degeneration controller 24 is provided with a disconnection state manager 242, a retry part 243, and a reconnection part 245, which reconnects to the disk device under temporary degeneration operation after updating unchanged part with data write operations during the temporary degeneration operation, and a disk power controller 244.

In addition, the disk array apparatus according to the present invention possesses a switch part 33a at each disk device 32. In FIG. 1, the disk device 32a is connected with the switch part 33a, and in the same way the other disk devices 32b to 32h are connected with corresponding switch parts 33b to 33h.

In FIG. 1, the disk array controller 2 interprets instructions received from the host computer 1.

When receiving write instructions, the array controller 31a generally assigns data received from the host computer 1 to the disk devices 32a to 32d and then writes them into the disk devices.

On the other hand, when receiving read instructions, each of the disk devices 32a to 32d generally transmits data, which is written in it, to corresponding array controller 31a. The array controller 31a generates complete data using the data from the disk devices 32a to 32d and then transmits it to the host computer 1 through the disk array controller 2.

If the failed disk specifying part 241 in the disk array controller 2 detects errors in operation of any of the disk devices 32a to 32d for write instructions, the failed disk specifying part 241 stores which disk device is failed into a storage part (not shown), such as memory, and then informs the disconnection state manager 242 in the temporary degeneration controller 24 of the failed disk device. Subsequently, the disconnection state manager 242 temporarily disconnects the failed disk device from the corresponding operation device in the disk array, allowing the failed disk device to be in temporary degeneration operation. The disk array controller 2 continues write operations for the remaining disk devices.

When the retry part 243 in the temporary degeneration controller 24 receives the error information from the failed disk specifying part 241 in the disk array controller 2, the retry part 243 performs the following processes (1) to (3) in parallel with performing general operations corresponding to read or write instructions:

(1) Perform the failed operations again and confirm whether the same errors occur. In the case of no error, the retry part 243 determines that the failed disk device returns to the normal state, and stores the error history.

(2) If the same errors occur, prohibit the use of the failed position and perform an internal operation, such as reassignment in which a substitute position is assigned.

(3) If errors occur after the reassignment and retry of read/write operations, turn off and then resupply power to the failed disk device, and then perform retry of write operations in (1).

On the other hand, if the failed disk specifying part 241 in the disk array controller 2 detects errors in operation of any of the disk devices 32a to 32d for read instructions, the failed disk specifying part 241 stores which disk device is failed into a storage part (not shown), and then informs the disconnection state manager 242 in the temporary degeneration controller 24 of the failed disk device. Subsequently, the disconnection state manager 242 temporarily disconnects the failed disk device from the corresponding operation device in the disk array, allowing the failed disk device to be in temporary degeneration operation. The disk array controller 2 continues read operations for the remaining disk devices.

When the retry part 243 in the temporary degeneration controller 24 receives error information from the failed disk specifying part 241 in the disk array controller 2, the retry part 243 performs the following processes (1) to (4) in parallel with the processing in the disk array controller 2:

(1) Perform the failed operations again and confirm whether the same errors occur. In the case of no error, the retry part 243 determines that the failed disk device returns to the normal state, and stores the error history.

(2) Rewrite the data at the failed position, allowing the data to be normally read, or

(3) Prohibit the use of the failed position and perform an internal operation, such as reassignment in which a substitute position is assigned.

(4) If errors occur after the reassignment and retry of read/write operations, turn off and then resupply power to the failed disk device, and then perform retry of read/write operations in (1) and (2).

At this point, the disk array controller 2 receives next instructions from the host computer 1 before completion of the internal operation for the failed disk device by the temporary degeneration controller 24, the disk array controller 2 performs operations corresponding to the instructions. However, if the instructions are data write operations, the disk array controller 2 stores write positions, at which data is written, into a storage part (not shown).

If the temporary degeneration controller 24 completes the internal processing for the failed disk device and write operations are in progress or completed in the disk array controller 2, the reconnection part 245 in the disk array controller 2 performs data recovery with data stored in the remaining disk devices based on the write positions stored in the storage part and then cancels the temporary degeneration operation to return to the normal operation.

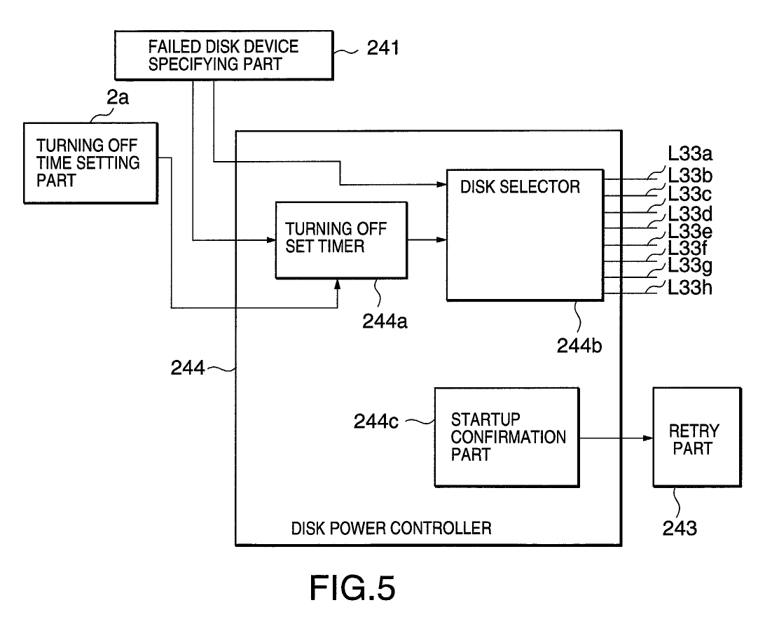

Referring now to FIG. 5, the disk power controller 244 possesses a turning off time set timer 244a, a disk selector 244b, and a startup confirmation part 244c. The turning off time set timer 244a outputs ON when the failed disk specifying part 241 instructs power-off. After a turning off time instructed by turning off time set part 2a, which sets a turning off time from power-off to power-on that is dependent on types of the diskdevice 32 in the disk array controller 2, the turning off time set timer 244a outputs OFF.

The disk selector 244b outputs OFF to a signal line (e.g., a signal line L32a if the failed disk device is the disk device 32a) connected to the switch part 33a, which is coupled with the failed disk device specifiedby the failed disk specifying part 241, while the turning off time set timer 244a outputs ON. On the other hand, when the turning off time set timer 244a outputs OFF, the disk selector 244b outputs ON.

The startup confirmation part 244c allows the disk array controller 2 to transmit a command to confirm whether the normal startup is performed after turning off and resupplying power for the failed disk device. Subsequently, the startup confirmation part 244c confirms whether the failed disk device reaches the normal idling state or normally starts up, and then informs the retry part 243 of the result.

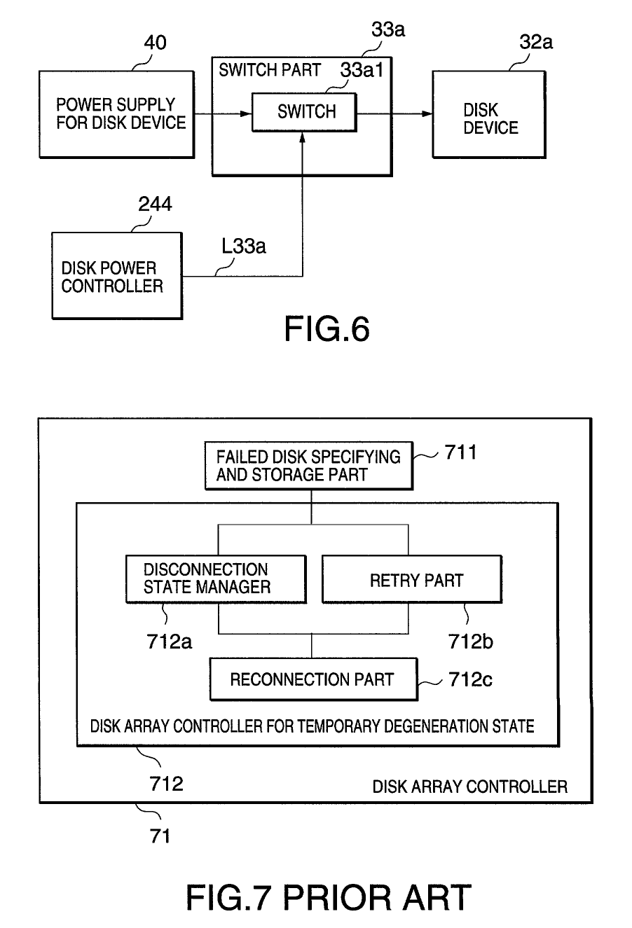

With reference to FIG. 6, the switch part 33a includes a switch 33a1. When the signal line L33a from the disk power controller 244 is ON, power current provided by a power supply for disk device 40 in the disk array apparatus is supplied to the disk device 32a1 through the switch part 33a. On the other hand, if the signal line L33a is OFF, the power current can not flow through the switch 33a1, resulting that power can not be supplied to the disk device 32a.

With such a structure, if retry operation is not normally completed in the retry part 243 during temporary degeneration operation by the disconnection state manager 242, the disk power controller 244 allows the switch part 33a corresponding to the failed disk device specified by the failed disk specifying part 241 to perform turning off and resupplying power for the disk device 32a. As described above, the disk power controller 244 and the switch parts 33a to 33h possess the turning off and resupplying power functions, so that they are referred to as a turning off and resupplying power part.

The disk power controller 244 monitors the disk device 32a after turning off and resupplying power. If the disk power controller 244 confirms the normal startup of the disk device 32a, the disk power controller 244 informs the retry part 243 of the result, and then the retry part 243 performs retry operation.

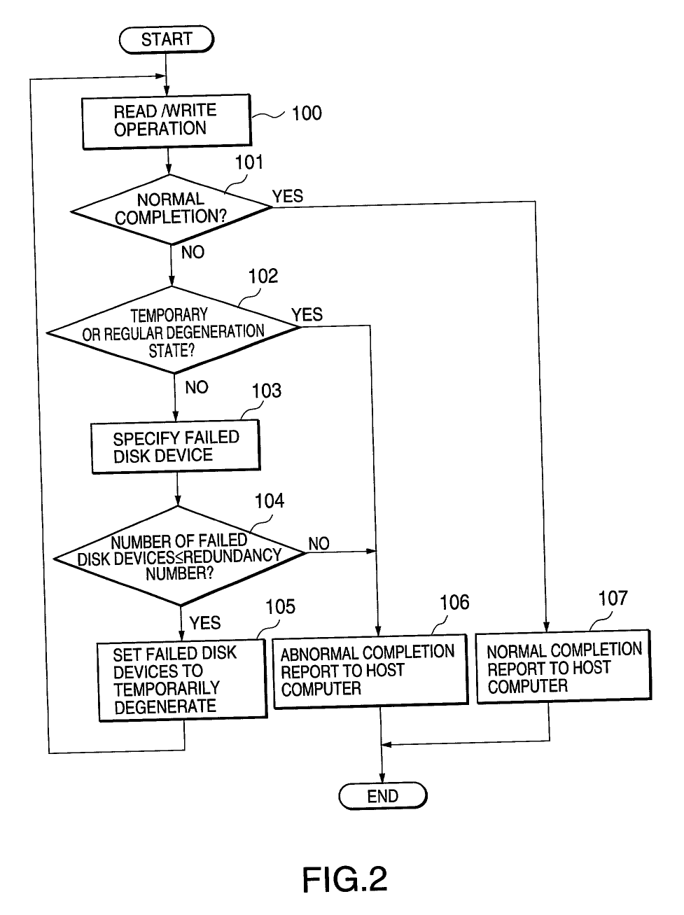

Hereinafter, an embodiment according to the present invention will be described. With reference to FIG. 2, operations of the temporary degeneration controller 24 will be explained. If the disk array apparatus receives data read/write instructions from the host computer 1, data transfer operations from/to each disk device, which constitutes the logical disk specified by the host computer 1 (Step 100). The temporary degeneration controller 24 confirms whether the data transfer operations are normally completed (Step 101). If normal completion, the temporary degeneration controller 24 informs the host computer 1 of normal completion (Step 107), and then finishes the control.

If not normal completion, the temporary degeneration controller 24 determines whether the logical disk is in a temporary or regular degeneration state (Step 102). In the case of the temporary or regular degeneration, the temporary degeneration controller 24 informs the host computer 1 of abnormal completion (Step 106), and then finishes the control.

If data transfer operations are abnormally completed and the logical disk is in neither a temporary nor a regular degeneration state, the temporary degeneration controller 24 determines in which disk device data transfer operations are abnormally completed (Step 103). If the number of failed disk devices is greater than redundancy of the logical disk, the temporary degeneration controller 24 informs the host computer of abnormal completion (Step 106), and then finishes the control. If the number of failed disk devices is equal to or less than the redundancy of the logical disk, the temporary degeneration controller 24 allows the specified failed disk device to be set in a temporary degeneration state (Step 105). Subsequently, the temporary degeneration controller 24 disconnects the failed disk device from the logical disk, and stores addresses, at which data read/write operations are abnormally completed, and information that the disk devices and the logical disk are in a temporary degeneration state into the disk array controller. After performing the above-described temporary degeneration processing, the processing is returned to Step 100 and retry of data read/write operations is performed.

The redundancy refers to the number, which is obtained by subtraction of the number of disk devices equal to actual storable capacity for a host computer from the number of physical disks (disk devices) that constitute a logical disk. For example, in RAID-3, in which a logical disk is constituted by four physical disks. In this system, if one physical disk is employed for parity, the number of disk devices corresponding to storable capacity for a host computer is three and the redundancy is one. In addition, in RAID-5, if the number of physical disks is six and two disk devices are employed for parity data, the number of disk devices corresponding to storable capacity for a host computer is four and the redundancy is two.

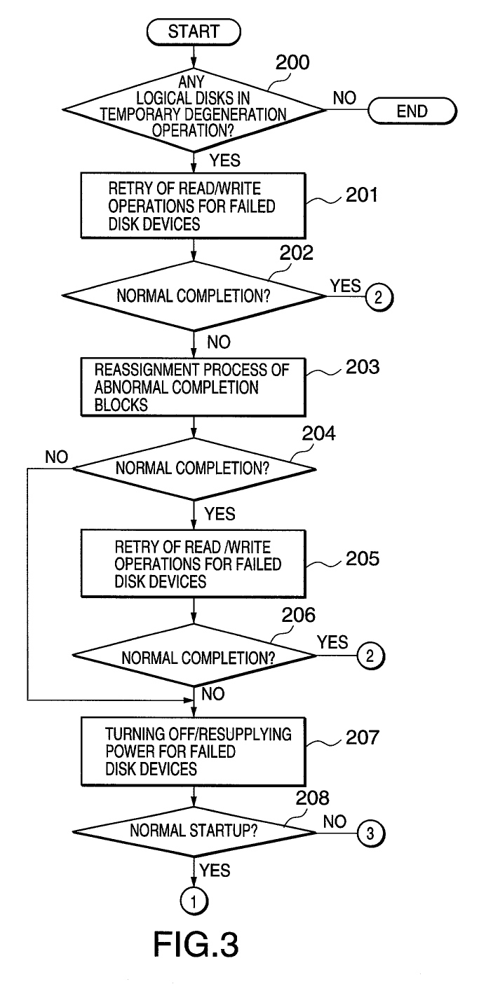

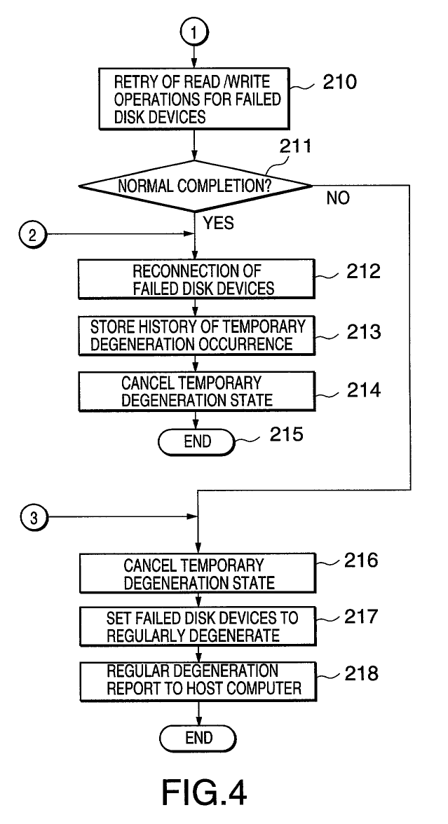

On the other hand, operations after the temporary degeneration processing are performed according to a flowchart shown in FIG. 3. The temporary degeneration controller 24 monitors temporary degeneration information of the logical disk asynchronously with instructions from a host computer, and determines whether the logical disk in a temporary degeneration state exists (Step 200). If such a logical disk exists, the following retry operations are performed. For the failed disc device in the logical disk, data read/write operations for the address, at which date read/write instructions fromthe host computer are not normally completed, are performed again (Step 201). If completed normally, the disk device (at first, the failed disk device) is reconnected to the logical disk (Step 212), and the history of temporary degeneration occurrence is stored into the disk array controller (Step 213). Subsequently, the temporary degeneration sate of the logical disk is canceled (Step 214), and the processing is finished.

In the retry of read/write operations in the failed disk device at Step 201 and determination whether the operations are normally completed at Step 202, only read operations are performed as retry if read operations are intended to be performed at first, or write operations are performed as retry if write operations are intended to be performed at first. Then, determination whether the operations are normally completed may be performed. Alternatively, if write operations are intended to be performed at first, write operations are performed as retry, and then determination whether the operations are normally completed may be performed. On the other hand, if read operations are intended to be performed at first, read operations are performed as retry, and then determination whether the operations are normally completed maybe performed. If completed normally, the retry is successful. If not so, read operations are further performed after write operations. If the read operations are normally completed, the retry is successful, but if not so, the operations as retry may be determined to be abnormal completion.

Steps 205 and 206, and Steps 210 and 211 can be explained the same as Steps 201 and 202 described above.

If re-read/re-write operations are abnormally completed at Step 201, reassignment processing, in which a failed block is prohibited to be used and an alternative block is assigned at Step 201, is performed (Step 203). Subsequently, determination whether the reassignment processing is normally completed is performed (Step 204). If completed normally, data read/write operations for the address are performed again (Step 205).

Further, determination whether this retry is normally completed is performed (Step 206). If completed normally, the disk device is connected to the logical disk again (Step 212), and then history of the temporary degeneration occurrence is stored into the disk array controller (Step 213). Finally, the temporary degeneration state of the logical disk is canceled (Step 214), and the processing is completed.

If the reassignment processing is not normally completed at above Step 203 or data read/write operations (Step 205) after normal completion of the reassignment are not normally completed, turning off and resupplying power processing for the failed disk device (Step 207). After resupplying power for the failed disk device, the failed disk device starts up normally, data read/write operations for the address, at which data read/write instructions from the host computer is abnormally completed, are performed again (Step 210). Subsequently, determination whether the operations are normally completed (Step 211), if normally completed, the disk device is connected to the logical disk again (Step 212) and the history of the temporary degeneration occurrence is stored into the disk array controller (Step 213). Finally, the temporary degeneration state of the logical disk is canceled (Step 214) and the processing is completed.

If the failed disk device does not normally start up after turning off/resupplying power operations at Step 207 or data read/write operations are not normally completed at Step 210 after the failed disk device normally starts up, the temporary degeneration state of the logical disk is canceled (Step 216). Subsequently, the failed disk device is disconnected from the logical disk, and then the logical disk is set in a regular degeneration state (Step 217). After transmitting information that the logical disk is in the regular degeneration state (Step 218) , and the processing is finished.

There exist various causes and situations for errors, which can be returned to normal conditions by turning off and resupplying power operations. As on of the situations, the processor, which is a controller in the apparatus, becomes uncontrollable, so that inside operations are failed and recovery of the normal state is impossible even if reset is performed.

As a first advantage of the present invention, if turning off/resupplying power operations can solve errors occurred at first, the failed disk device is returned to the normal state, in which data read/write operations can be performed, and connected to the logical disk again, enabling the logical disk to return to the normal state. As a result, expensive replacement of disk devices due to regular degeneration is avoidable.

The reason is that, in this processing, turning off and resupplying power operations are introduced for failed disk devices, which can not normally complete data read/write operations even if reassignment processing is performed.

As a second advantage of the present invention, if turning off/resupplying power operations can solve errors occurred at first, the failed disk device is returned to the normal state, in which data read/write operations can be performed, and connected to the logical disk again, enabling the logical disk to return to the normal state. As a result, decrees of reliability due to regular degeneration for a long time is avoidable.

The reason is that, in this processing, turning off and resupplying power operations are introduced for failed disk devices, which can not normally complete data read/write operations even if reassignment processing is performed.

While the present invention has been described with reference to illustrative embodiments, this description is not intended to be construed in a limiting sense. Various modifications of the illustrative embodiments as well as other embodiments of the invention, will be apparent to persons skilled in the art upon reference to this description. It is, therefore, contemplated that the appended claims will cover any such modifications or embodiments as fall within the truescope of the invention.

What is claimed is:

1. A disk array apparatus having plural disk devices with redundancy for performing data read/write operations between the disk array apparatus and a host computer in response to data read/write instructions from the host computer, comprising:
a failed disk specifying and storage part which detects errors in either data write or read operations and stores which disk device is failed;
a disconnection state manager which disconnects temporarily the failed disk device and manages the disk array apparatus under temporary degeneration operation;
an instruction execution part which allows the remaining normal disk devices to perform data read/write operations using redundancy when receiving data read/write instructions from the host computer during temporary degeneration operation;
a retry part which performs retry of incomplete data read/write operations at the failed disk device in parallel with performing data read/write operations between the disk devices and the host computer; and
a turning off and resupplying power part which turns off and then resupplies power to the failed disk device if normal completion is not achieved with retry by the retry part,
wherein the retry part performs retry again after turning on the power for the device.

2. The disk array apparatus according to claim 1, further comprising:
a reconnection part which cancels the temporary disconnected state of a failed disk device and returns the disk array apparatus from temporary degeneration operation to the normal operation if the failed disk device becomes normal after retry by the retry part.

3. The disk array apparatus according to claim 2, wherein if the turning off and resupplying power part turns off and resupplies power to the failed disk device, and then the retry part performs retry to achieve normal completion and the reconnection part connects the temporarily disconnected disk device to the disk array apparatus, history of the process is stored into the disk array controller.

4. The disk array apparatus according to claim 2, wherein the turning off and resupplying power part comprises:
a disk power controller which transmits a signal to a switch part connected to the failed disk device specified by the failed disk specifying and storage part to turn off the switch for a predetermined time from the moment specified by the failed disk specifying and storage part; and
a switch part which is connected between the disk device and power supply of the disk device, normally supplying power current to the disk device from the power supply and cutting off the power current during receiving a turning off signal from the disk power controller.

5. The disk array apparatus according to claim 3, wherein the turning off and resupplying power part comprises:
a disk power controller which transmits a signal to a switch part connected to the failed disk device specified by the failed disk specifying and storage part to turn off the switch for a predetermined time from the moment specified by the failed disk specifying and storage part; and
a switch part which is connected between the disk device and power supply of the disk device, normally supplying power current to the disk device from the power supply and cutting off the power current during receiving a turning off signal from the disk power controller.

6. The disk array apparatus according to claim 4, wherein the disk power controller comprises:
a turning off time set timer which outputs an instruction signal to a disk selector from the moment instructed by the failed disk specifying and storage part for a time predetermined depending on types of disk devices; and
a disk selector which transmits a turning off signal to the switch part that is connected to the failed disk device specified by the failed disk specifying and storage part while the instruction signal is transmitting from the turning off time set timer.

7. The disk array apparatus according to claim 5, wherein the disk power controller comprises:
a turning off time set timer which outputs an instruction signal to a disk selector from the moment instructed by the failed disk specifying and storage part for a time predetermined depending on types of disk devices; and
a disk selector which transmits a turning off signal to the switch part that is connected to the failed disk device specified by the failed disk specifying and storage part while the instruction signal is transmitting from the turning off time set timer.

8. An error control method for disk array apparatus, which is provided with plural disk devices with redundancy and performs data read/write operations between the disk array apparatus and a host computer corresponding to data read/write instructions from the host computer, comprising:
a step 1 of detecting any problems in either data write or read operations and storing which disk device is failed;
a step 2 of temporarily disconnecting the failed disk device and managing the disk array apparatus under temporary degeneration operation;
a step 3 of allowing the remaining normal disk devices to perform data read/write operations with the host computer using redundancy in response to data read/write instructions from the host computer during temporary degeneration operation;
a step 4 of performing retry of incomplete data read/write operations at the failed disk device in parallel with performing data read/write operations between the disk array apparatus and the host computer; and
a step 5 of turning off and then resupplying power to the failed disk device if there try by the step 4 cannot normally finish the incomplete data read/write operations,
wherein the step 4 is further performed after performing the step 5.

9. The error control method for the disk array apparatus according to claim 8, further comprising:
a step 6 of canceling a temporary disconnected state of the failed disk device and returning the disk array apparatus from temporary degeneration operation to the normal operation if the failed disk device becomes normal after retry in the step 4.

10. The error control method for the disk array apparatus according to claim 8, wherein in the step 4, failed operations are performed again to confirm whether the same problems occur and the failure history is stored if the same problems do not occur.

11. The error control method for the disk array apparatus according to claim 9, wherein in the step 5, failed operations are performed again to confirm whether the same problems occur and the failure history is stored if the same problems do not occur.

12. The error control method for the disk array apparatus according to claim 8, wherein in the step 4, data at a failed position is re-written so as to be normally read.

13. The error control method for the disk array apparatus according to claim 9, wherein in the step 4, data at a failed position is re-written so as to be normally read.

14. The error control method for the disk array apparatus according to claim 8, wherein in the step 4, a failed position in the failed disk device is prohibited to be used and then a replacement position is assigned if the failure is a read error due to physical defects in the medium.

15. The error control method for the disk array apparatus according to claim 9, wherein in the step 4, a failed position in the failed disk device is prohibited to be used and then a replacement position is assigned if the failure is a read error due to physical defects in the medium.

16. A computer program capable of running on a disk array apparatus as a computer so that the computer performs said steps of claim 8.
